(19) United States
(12) Patent Application Publication
(10) Pub. No.: US 2008/0238781 A1
(43) Pub. Date: Oct. 2, 2008

(54) PATCH ANTENNA WITH AN L-SHAPED CUT CORNER

(75) Inventors: CHIH-MING SU, TAIPEI CITY (TW); HUNG-YI LO, KEELUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: SINBON ELECTRONICS CO., LTD., TAIPEI HSIEN (TW)

(21) Appl. No.: 11/753,923

(22) Filed: May 25, 2007

(30) Foreign Application Priority Data
Mar. 30, 2007 (TW) 096111360

(51) Int. Cl. H01Q 1/38; H01Q 9/04

(52) U.S. Cl. 343/700 MS

(57) ABSTRACT

The present invention discloses a patch antenna with an L-shaped cut corner. The patch antenna includes a substrate, a patch, a ground plate and a feed point. The substrate has corresponding first surface and second surface. The patch is installed on the first surface of the substrate. At least one corner of the patch forms the L-shaped cut corner, and two arms of the L-shaped cut corner are disposed at two edges of the patch. The second surface of the substrate includes a ground plate, and the patch includes a feed point for transmitting and receiving feed-in or feed-out wireless signals.

### BACKGROUND OF THE INVENTION

1. Field of the Invention

The present invention relates to a patch antenna with an L-shaped cut corner, and more particularly to a patch antenna that adjusts an L-shaped cut corner to achieve an antenna having a circular polarization radiation characteristic and can maintain the center frequency and input impedance of the patch antenna during adjustment.

2. Description of the Related Art

Antenna is an important and indispensable component of the present popular wireless electronic products, and its main function is to generate microwave signals in the electronic products, and radiate the signals in air or receive the signals from the air into the systems of the electronic products. The quality of antenna in the electronic products, or the compatibility of antenna have significant effects on the transmitted or received microwave signals, as well as the performance of a radio frequency circuit and a digital circuit of the electronic products. Thus, electronic product designers and manufacturers have to pay more attention to the radiation performance of an antenna, and its effect on the system of electronic products when they design the antenna or install the antenna to a product.

At present, antennas having the feature of producing circular polarization radiation are widely used in the area of satellite communications, and such antennas have a good effect on overcoming the multi-path interference, and conventional circular polarization antennas are mainly divided into the following three types according to their structure and characteristics:

(1) Patch antenna: Referring to FIG. 1, a patch antenna 10 is a popular design that adopts a ceramic material as its substrate, and uses a mold and a shaping machine to produce a ceramic board. The substrate board 11 is obtained after the ceramic board is sintered. A square or rectangular patch 12 and a ground plate 13 are formed on upper and lower surfaces of the substrate board 11 respectively, and then uses a feed pin 14 to pass through the patch 12 and substrate board 11 sequentially and connect with an electric wave signal feed line 15 (such as a coaxial cable), such that a resonant cavity is formed between the patch 12 and the ground plate 13, for producing a high-frequency electromagnetic field. Electric wave signals are radiated to the outside through the gap between the surrounding of the patch 12 and the ground plate 13. Traditionally, the circular polarization radiation characteristic of such antenna 10 bases on the two opposite corners, each having a cut triangle 121 with a specific size of the square or rectangular patch 12 to produce two degenerate perpendicular modes with substantially equal frequencies. The directions of two degenerate modes are perpendicular to one other, and the phase difference between the two degenerate modes is 90-degree. In general, the patch antenna 10 features the advantages of small size, strong structure, high reliability to temperature and low power loss. However, extreme care is needed for designing the two cut triangles 121 at the opposite corners of such antenna 10, or else the circular polarization cannot be produced, and the impedance match and resonant frequency cannot be achieved.

(2) Patch antenna being fed signals through a power divider: Referring to FIG. 2, a patch antenna 20 adopts a general circuit board as its substrate 21, and a square or rectangular patch 22 and a ground plate 23 are printed on upper and lower surfaces of the substrate 21 respectively, and a transmission line 241 and 242 is extended from a center position of two adjacent sides of the patch 22, and the two transmission lines 241 and 242 are connected to a power divider 25 or a related component. The power divider 25 receives electric wave signals which will be fed into the antenna 20 through a circuit 26. Before the electric wave signals are fed into the patch 22, the power divider 25 is used for dividing the electric wave signal evenly, and a 90-degree phase difference among the evenly divided electric wave signals is produced because the transmission line 241 is extended for a quarter of a wavelength. The evenly divided electric wave signals are fed into the patch 22 to achieve the required circular polarization characteristic of the antenna.

(3) The patch antenna being fed signal by a 90-degree coupler: Referring to FIG. 3 for the concept of such antenna 30. Similar to the antenna 20 as shown in FIG. 2, both uses the feed-in signals with a 90-degree difference to activate two perpendicular radiations of the antenna. In FIG. 3, the antenna 30 adopts a general circuit board as its substrate 31, and uses silk-screen printing and etching technology to print a square or rectangular patch 32 and a ground plate 33 onto upper and lower surfaces of the substrate 31 respectively, and a transmission line 341 and 342 is extended from a center position of two adjacent sides of the patch 32, and the two transmission lines 341 and 342 are connected to a 90-degree coupler 35 or a related component, and the 90-degree coupler 35 receives electric wave signals which will be fed into the antenna 30 through a circuit 36. Before the electric wave signals are fed into the patch 32, the 90-degree coupler 35 is used for dividing the electric wave signals evenly and producing a 90-degree phase difference. These evenly divided electric wave signals are fed into patch 32 to achieve the required circular polarization characteristic of the antenna.

In view of the description above, antenna designers and manufacturers cut a triangle from the patch, or add a control component to make the fed electric wave signals having 90-degree phase difference in order to achieve the required circular polarization characteristic of the antenna. However, the center frequency and the input impedance of the antenna may vary greatly to affect the quality of signals, if the manufacturing precision of cutting the triangle from the patch is not high enough, or during fine-tune of circular polarization characterized of the antenna. As a result, a redesign or a later fine-tune manufacture is required, and thus causing a complicated manufacturing procedure and incurring a high manufacturing cost. By adding a control component, the level of difficulty and the manufacturing cost will be increased. Even if the design can be completed, it is necessary to comply with the practical need and produce a bigger antenna with microstrips, and such design is obviously incompliant with the trend of a light, thin, short and compact design.

In view of the aforementioned shortcomings of the prior art, the inventor of the present invention based on years of experience to conduct extensive researches and experiments, and finally developed a patch antenna with an L-shaped cut corner in accordance with the present invention to overcome the shortcomings of the prior art.

### SUMMARY OF THE INVENTION

The primary objective of the present invention is to overcome the foregoing shortcomings of the prior art by providing a patch antenna with an L-shaped cut corner to overcome the difficulty and barrier on the design of an antenna with a circular polarization radiation characteristic, and creating an L-shaped cut corner on the patch to adjust the circular polarization radiation characteristic of the antenna and maintaining the center frequency and input impedance of the patch antenna.

To achieve the foregoing objective, the present invention provides a patch antenna with an L-shaped cut corner, and the patch antenna comprises a substrate, a patch, a ground plate and a feed point. The substrate has corresponding first surface and second surface, and the patch is disposed on the first surface of substrate. The patch has at least one corner which is an L-shaped cut corner, and two arms of the L-shaped cut corner are disposed at two edges of the patch. The ground plate is disposed on the second surface of the substrate, and a feed point is disposed on the patch for transmitting and receiving feed-in or feed-out wireless signals. The circular polarization characteristic of the patch antenna with an L-shaped cut corner of the invention can be adjusted by adjusting the length, the width or both of the two arms of the L-shaped cut corner, and the performance of the center frequency and the input impedance of the patch antenna can be maintained during the adjustment of the L-shaped cut corner. To make it easier for our examiner to understand the present invention, the following detailed description with reference to the accompanying drawings of embodiments are given for example, but such preferred embodiment is not intended to limit the scope of the present invention.

### BRIEF DESCRIPTION OF THE DRAWINGS

FIG. 1 is a schematic structural view of a conventional antenna;

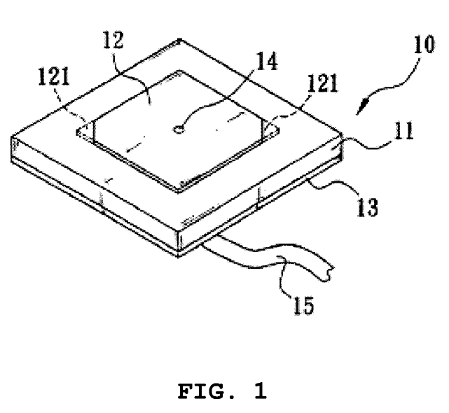

FIG. 2 is a schematic structural view of a conventional antenna that feeds signals through a power divider;

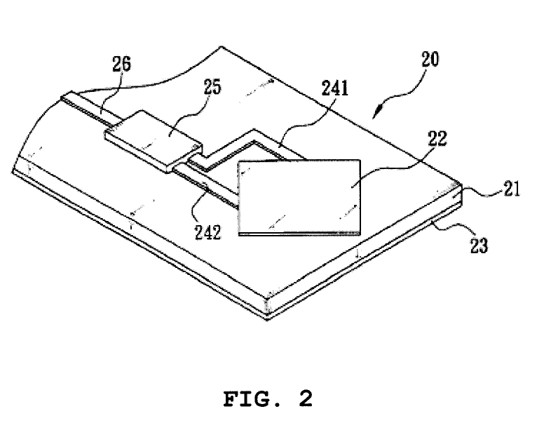

FIG. 3 is a schematic structural view of a conventional antenna that feeds signals through a 90-degree coupler;

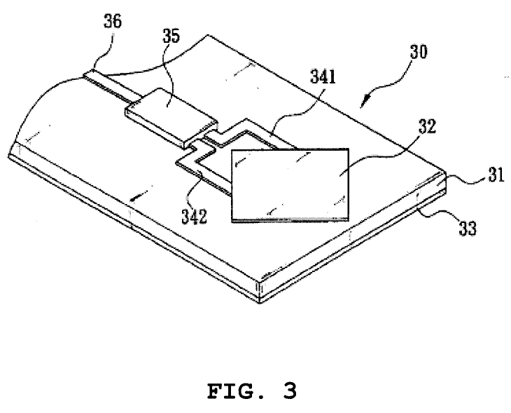

FIG. 4 is a schematic structural view of a patch antenna with an L-shaped cut corner in accordance with the present invention;

FIG. 5 is a bottom view of a patch antenna with an L-shaped cut corner in accordance with the present invention;

FIG. 6 is a top view of a patch antenna with an L-shaped cut corner in accordance with the present invention;

FIG. 7 is a graph of S parameter versus frequency of a patch antenna with an L-shaped cut corner in accordance with the present invention; and

FIG. 8 is a graph of axial ratio versus frequency of a patch antenna with an L-shaped cut corner in accordance with a preferred embodiment of the present invention.

### DETAILED DESCRIPTION OF THE PREFERRED EMBODIMENTS

For simplicity, like numerals are used for like elements for the description of the specification of the present invention.

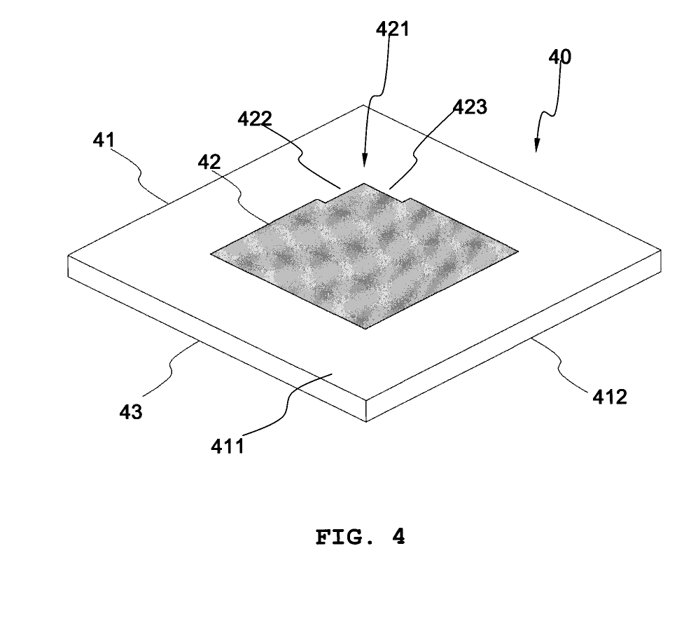

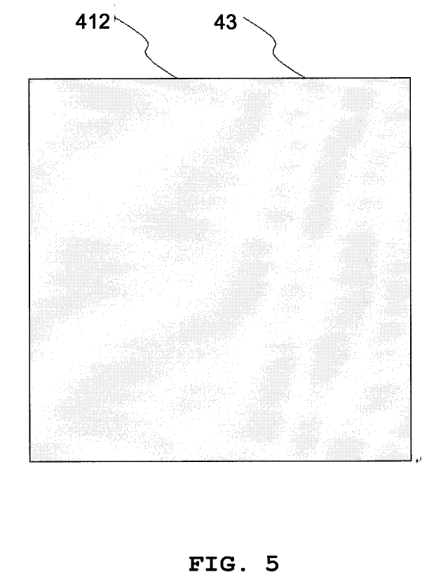

Referring to FIGS. 4 and 5 for a schematic structural view and a bottom view of a patch antenna with an L-shaped cut corner in accordance with the present invention, the patch antenna with an L-shaped cut corner 40 comprises a substrate 41, a patch 42, a ground plate 43 and a feed point (not shown in the figure), wherein the substrate 41 has corresponding first surface 411 and second surface 412, and the patch 42 is disposed on the first surface 411 of the substrate 41 but not necessarily covered on the entire first surface 411. At least one corner of the patch 42 is an L-shaped cut corner 421, and two arms 422, 423 of the L-shaped cut corner 421 are disposed at two edges of the patch 42. The ground plate 43 is disposed on the second surface 412 of the substrate 41 and covered onto the entire second surface 412, and the patch 42 includes a feed point (not shown in the figure) for transmitting and receiving feed-in or feed-out wireless signals.

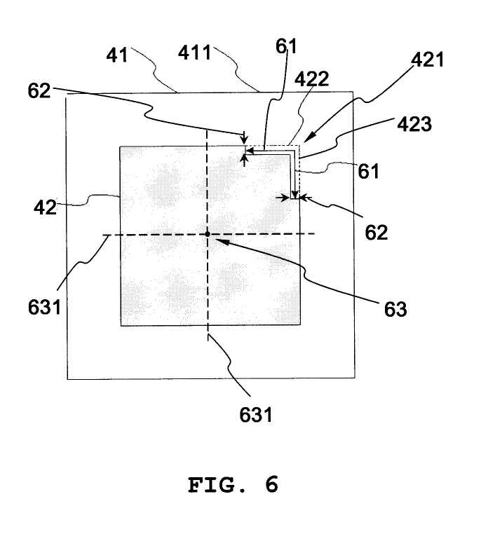

Referring to FIG. 6 for a top view of a patch antenna with an L-shaped cut corner in accordance with the present invention, length 61 and the width 62 of the two arms 422, 423 of the L-shaped cut corner 421 of the patch antenna with an L-shaped cut corner 40 are adjusting parameters of the L-shaped cut corner 421. The length 61, or the width 62, or both length 61 and width 62 of the two arms 422, 423 can be adjusted according to the desired circular polarization characteristic of the design requirement. The feed point is disposed on one of two axes 631, 632 intersected perpendicularly at a center 63 of the patch 42, or outsides two axes 631, 632. Therefore, the position of the feed point can be adjusted according to the desired resonant frequency and input impedance of the design requirement.

The substrate 41 of the foregoing patch antenna with an L-shaped cut corner 40 is a medium substrate which can be a non-conducting material (such as PCB or ceramic board). The feed point is connected to a feed line which is generally a coaxial cable or a microstrip line.

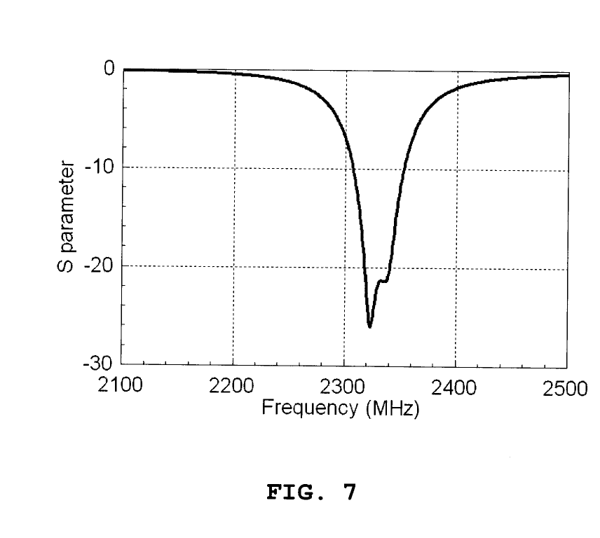

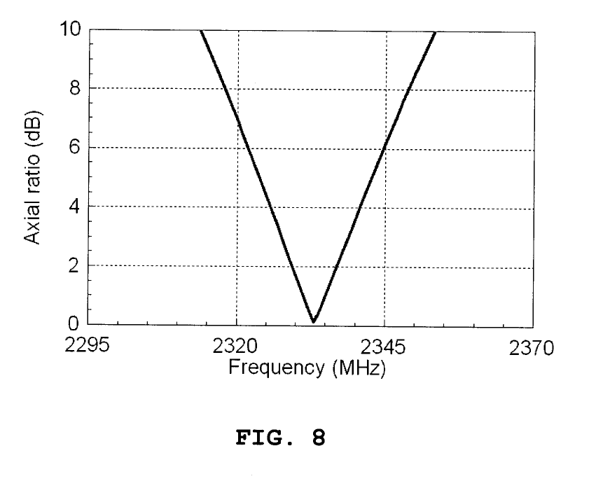

Referring to FIGS. 7 and 8 for a graph of S parameter versus frequency and a graph of axial ratio versus frequency of a patch antenna with an L-shaped cut corner in accordance with a preferred embodiment of the present invention respectively, the patch antenna with an L-shaped cut corner 40 is designed with a specific frequency, and the graph of S parameter versus frequency and the graph of axial ratio versus frequency show very satisfactory results. Particularly for the design of a circular polarization antenna, it is very difficult to have an axial ratio approaching 0 dB, but the present invention has overcome this difficulty and provides an axial ratio substantially close to 0 dB.

In summation of the description above, the patch antenna with an L-shaped cut corner in accordance with the present invention can maintain the performance of its center frequency and/or input impedance, while adjusting the circular polarization characteristic of the patch antenna, and thus the invention enhances the prior art and also complies with the patent application requirements.

The description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A patch antenna with an L-shaped cut corner, comprising:
a substrate having a first surface and a second surface corresponding to each other;
a patch disposed on said first surface of said substrate, and at least one corner of said patch forming an L-shaped cut corner and two arms of said L-shaped cut corner being disposed at two edges of said patch;
a ground plate disposed on said second surface of said substrate; and
a feed point, disposed on said patch.

2. The patch antenna with an L-shaped cut corner of claim 1, wherein said substrate comprises a medium substrate, and said medium substrate includes a non-conducting material.

3. The patch antenna with an L-shaped cut corner of claim 1, wherein said feed point is disposed on one of two intersected axes at a center of said patch.

4. The patch antenna with an L-shaped cut corner of claim 1, wherein said feed point is disposed outside an axis of two intersected axes at a center of said patch.

5. The patch antenna with an L-shaped cut corner of claim 1, wherein said feed point is connected to a feed line.

6. The patch antenna with an L-shaped cut corner of claim 5, wherein said feed line includes a coaxial cable.

7. The patch antenna with an L-shaped cut corner of claim 5, wherein said feed line includes a microstrip line.
